(19) United States
(12) Patent Application Publication
(10) Pub. No.: US 2026/0336199 A1
(43) Pub. Date: Oct. 29, 2026

(54) DEVICE AND METHOD FOR CURING A LINER PULLED INTO A PIPE IN AN INVERSION METHOD

(71) Applicant: BRAWO SYSTEMS GmBH, Kaiserslautern (DE)

(72) Inventors: Christopher Schmitt, Otterbach (DE); Maximilian Fritz, Rutsweiler (DE)

(21) Appl. No.: 19/106,988

(22) PCT Filed: Aug. 16, 2023
(86) PCT No.: PCT/EP2023/072506

§ 371 Date: Feb. 26, 2025

(30) Foreign Application Priority Data
Aug. 30, 2022 (DE) 10 2022 121 917.8

(51) Int. Cl. B29C 63/36; B29C 35/08; B29L 23/00

(52) U.S. Cl. CPC B29C 63/36; B29C 35/0805; B29C 2035/0827; B29L 2023/22

(57) ABSTRACT

The present invention relates to a device (100, 200) for curing a liner (20) pulled into a pipe (10) in an inversion method. The device (100, 200) comprises a body element (110) having a first end portion (112) and a second end portion (114); a pneumatic coupling (120) at the first end portion (112) of the body element (110), the pneumatic coupling (120) being designed to be connected to a liner (20) to be inverted; and a tension coupling (130) at the second end portion (114) of the body element (110), the tension coupling (130) being designed to be connected to a tension cable (30).

The present disclosure relates to a device for curing a liner drawn into a pipe in an inversion process and to a method for curing a liner drawn into a pipe in an inversion process. In particular, the present disclosure relates to a remote separation of a curing head from an end of a liner.

### PRIOR ART

Pipes for sewer systems, for example, can be restored by inserting a flexible tubular liner with a resin-impregnated inner surface into the pipe using an inversion process. In this inversion process, air or water is introduced into the inside of the liner, causing the liner to progressively adhere to the inner wall of the pipe. To pressurize the inside of the liner, one end of the liner can be attached to an air or water supply device. The other end of the liner, which is pulled into the pipe, can be closed. The closed end moves into the pipe as the liner continues to be inverted.

Once the liner has been inserted, the resin can be cured with heat or UV light so that the liner bonds firmly to the pipe. For this purpose, a curing head, which is connected to the closed end of the liner, can be pulled into the pipe together with the liner. After the liner and the curing head have been pulled into the pipe, the connection between the curing head and the liner can be released and the curing head can be pulled back to the entrance of the pipe by means of a pull cable and under heat or light radiation to cure the resin.

However, it is often only possible to retract the curing head if there is access at the destination to manually separate the retracted end of the liner from the curing head. In addition, the liner must be depressurized during separation. Releasing the pressure for the separation and repressurizing for the duration of the curing process can, for example, trap air in the liner, which impairs the quality of the restoration of the pipe.

### DISCLOSURE OF THE INVENTION

It is an object of the present disclosure to provide a device for curing a liner drawn into a pipe in an inversion process and a method for curing a liner drawn into a pipe in an inversion process, which enable a connection between the liner and the device to be released remotely. In particular, it is an object of the present disclosure to separate a curing head from a closed end of a liner without releasing the pressure in the liner. A further object is to disclose a device for curing a liner which is small in its dimensions and can also be used for pipes with a small internal diameter and/or small curing heads.

This object is achieved by the subject matter of the independent claims. Advantageous embodiments are given in the dependent claims.

According to an independent aspect of the present disclosure, a device for curing a liner drawn into a pipe in an inversion process is disclosed. The device can also be referred to as a “curing head”.

The device comprises a body element having a first end portion and a second end portion; a pneumatic coupling at the first end portion of the body element, wherein the pneumatic coupling is adapted for connection to a liner to be inverted; and a traction coupling at the second end portion of the body element, wherein the traction coupling is adapted for connection to a pull cable.

According to the invention, a pneumatic coupling is provided on the curing head and enables the curing head to be pneumatically disconnected from the liner remotely after the liner has been drawn into the pipe. After disconnecting from the liner, the curing head can be pulled out of the pipe by means of the pull cable, wherein the curing head can radiate, e.g. heat or light, while being pulled out in order to cure the liner that has been pulled into the pipe. This means, for example, that it is not necessary to release the pressure in the liner after the liner has been pulled in and before the curing head is pulled out. As a result, the quality of the pipe restoration can be improved. In addition, the pneumatic coupling can be small so that little installation space is required for the pneumatic coupling and can also be used for pipes with a small internal diameter and/or small curing heads.

The term “inversion process”, as used in the context of the present disclosure, refers to a process in which a flexible, tubular liner with a resin-impregnated inner surface, for example, is drawn into a pipe. For this purpose, a medium such as air or water is introduced into the interior of the liner, whereby the liner progressively adheres to the inner wall of the pipe. In order to pressurize the inside of the liner, one end of the liner is attached to an air or water supply device. The other end of the liner, which is pulled into the pipe, is closed. The closed end moves into the pipe as the liner continues to be turned upside down to line the inner wall of the pipe, wherein the resin-impregnated inner side of the liner lies against the inner wall of the pipe after being pulled in or inverted.

Preferably, the pipe is a pipe to be restored or a sewer to be restored, such as a wastewater sewer. However, the present disclosure is not limited thereto and the pipe can be any pipe into which a liner can be inserted for the purpose of reinforcement and/or restoration.

The liner consists of a flexible material, such as corrosion-resistant synthetic and/or glass fibers.

The liner is prepared with a curable material that adheres to the inner wall of the pipe after it has been pulled in or inverted. The curable material can be a resin, for example. In some embodiments, the curable material can be cured by irradiating the curable material with energy, such as thermal energy or light, in particular UV light.

Preferably, the pneumatic coupling comprises a cylinder and a piston, which is arranged in the cylinder so as to be movable along the longitudinal axis of the cylinder and the body element. Together with the cylinder, the piston forms a sealed cavity, the volume of which changes as a result of the movement of the piston within the cylinder. The piston can be moved by pressurizing the cylinder.

Preferably, the cylinder is connected to a pressure generating device outside the pipe via a pressure line, in particular a compressed air line, so that a pressure medium (e.g. compressed air) can be supplied to the cylinder from outside. Means are also provided to relieve the pressure, i.e., to release the pressure on the cylinder. This can be done, for example, by opening a valve and/or a lever outside the pipe and via the pressure line.

Preferably, the piston has an outer diameter of 1 mm to 10 mm, 1 mm to 5 mm or 1 mm to 3 mm. For example, the outer diameter of the piston can be around 2 mm.

Preferably, the piston can move linearly within the cylinder. In particular, the piston can be movable along a longitudinal axis of the cylinder.

Preferably, the cylinder extends through the body element. In particular, the cylinder can extend at least partially between the first end portion and the second end portion of the body element. The piston can be moved such that it emerges from the cylinder at the first end portion to fix the liner to the first end portion of the body element.

Preferably, the cylinder and the piston extend along a longitudinal axis of the body element, which is defined between the first end portion and the second end portion.

Preferably, the cylinder and the piston are arranged substantially centrally in the body element.

Preferably, the piston is movable between a first position or stance and a second position or stance. For example, the piston can move linearly between the first position or stance and the second position or stance.

Preferably, the piston is set up to hold the liner in the first position and to release the liner in the second position. The first position can thus be a closed position (corresponding to a closed pneumatic coupling), and the second position can be an open position (corresponding to an open pneumatic coupling).

In some embodiments, in the first position, the piston can protrude or extend from the cylinder at the first end portion of the body element to engage with the liner or a fastening element on the liner to secure the liner to the first end portion of the body element. The piston can be moved from the first position to the second position so that the piston does not protrude or protrudes only slightly from the cylinder at the first end portion of the body element in order to release the liner or the fastening element on the liner.

Preferably, the piston is set up to move from the second position to the first position when pressure is applied and to move from the first position to the second position when pressure is released. Alternatively, the piston can be set up to move from the first position to the second position when pressure is applied and to move from the second position to the first position when pressure is released.

Preferably, the device further comprises at least one elastic element arranged to exert a force on the piston in the direction of the second position. For example, the at least one elastic element can move the piston from the first position to the second position when pressure is released, in particular press it to release the liner. The force exerted on the piston by the application of pressure can be greater than the elastic force exerted by the at least one elastic element, so that the piston can be moved into the first position against the elastic force when pressure is applied and can hold the liner.

Preferably, the at least one elastic element comprises or is a spring, such as a coil spring.

Preferably, the device further comprises a receiving element set up to receive an end portion of the piston in the first position. The end portion of the piston corresponds to the end of the piston that protrudes from the cylinder when the piston is in the first or closed position. This allows an open end of the piston to be fixed so that damage or deformation of the piston can be prevented by a tensile force exerted on the piston by the liner. In addition, accidental release of the liner from the pneumatic coupling can be avoided.

Preferably, the receiving element is arranged in or on the first end portion of the body element. Preferably, the receiving element has an opening into which the piston can be inserted. The end portion of the piston can be inserted into the opening in the first position of the piston and cannot be inserted into the opening in the second position.

Preferably, the opening is a recess, a hole or a through-hole in the receiving element.

Preferably, the body element has an indentation or recess at the first end portion, in particular at an end face of the body element, in which the outlet of the cylinder and the receiving element are arranged.

Preferably, the receiving element is a projection and/or a web. The projection or web can extend over the cylinder so that the piston hits the receiving element when it extends out of the cylinder. For example, the opening can be arranged coaxially with the longitudinal axis of the cylinder and/or the longitudinal axis of the piston, so that the piston can be inserted into the opening by the movement into the first position.

Preferably, the receiving element has a wedge shape. In some embodiments, the wedge-shaped receiving element can taper from a fastened end towards an open end and thus can be wider at the fastened end. This can prevent the liner from getting caught when the pneumatic coupling is opened and from becoming detached from the pneumatic coupling.

Preferably, the receiving element is connected to the body element or is formed in one piece with the body element.

Preferably, the device further comprises a receiving space formed between one end of the cylinder and the receiving element. The receiving space can be open on one side so that an eyelet of the liner or an eyelet of a fastening element connected to the liner can be inserted into the receiving space when the piston is in the second position. The piston can extend through the eyelet and close the previously open side of the receiving space when the piston is in the first position in order to hold the liner.

Preferably, the device also comprises at least one curing device, which is arranged on the body element. The curing head thus simultaneously forms the holding system for the liner.

The at least one curing device is set up to emit energy for curing the liner drawn into the pipe, such as heat or light, in particular UV light. Typically, the at least one curing device comprises one or more LEDs.

Preferably, a plurality of curing devices, such as a plurality of LEDs, are arranged concentrically around the longitudinal axis of the body element, preferably on an outer side of the body element. In particular, the plurality of curing devices can be arranged around the cylinder and the piston.

Preferably, the body element has a diameter in the range of 1 cm to 10 cm, 1 cm to 5 cm or 1 cm to 3 cm. The diameter of the body element can be around 2 cm, for example.

Preferably, the device has a pneumatic coupling with a cylinder and a piston. Alternatively, the device can have several pneumatic couplings, each with a cylinder and a piston.

According to an independent aspect of the present disclosure, there is described a method for curing a liner drawn into a pipe in an inversion process using the device described herein. The method comprises inverting the liner into the pipe from a starting point, wherein the liner is connected to the pneumatic coupling of the device so that the device is also drawn into the pipe; opening the pneumatic coupling after the liner is drawn in to release the connection between the device and the liner; and pulling the device back to the starting point by a pull cable connected to the traction coupling of the device and radiating energy to cure the liner.

The method can implement the aspects described in relation to the device for curing a liner drawn into a pipe in an inversion process.

### BRIEF DESCRIPTION OF THE DRAWINGS

Exemplary embodiments of the disclosure are shown in the figures and are described in greater detail below. In the figures:

FIG. 1 shows a schematic drawing of a liner and a curing head in a pipe,

FIG. 2 schematically shows the curing head being pulled out of the pipe to cure the liner,

FIG. 3 schematically shows a device for curing a liner drawn into a pipe in an inversion process with an open pneumatic coupling according to embodiments of the present disclosure,

FIG. 4 schematically shows a device for curing a liner drawn into a pipe in an inversion process with a closed pneumatic coupling according to embodiments of the present disclosure,

FIG. 5 schematically shows a device for curing a liner drawn into a pipe in an inversion process according to further embodiments of the present disclosure, and

FIG. 6 shows a flow chart of a process for curing a liner drawn into a pipe in an inversion process according to embodiments of the present disclosure.

### EMBODIMENTS OF THE DISCLOSURE

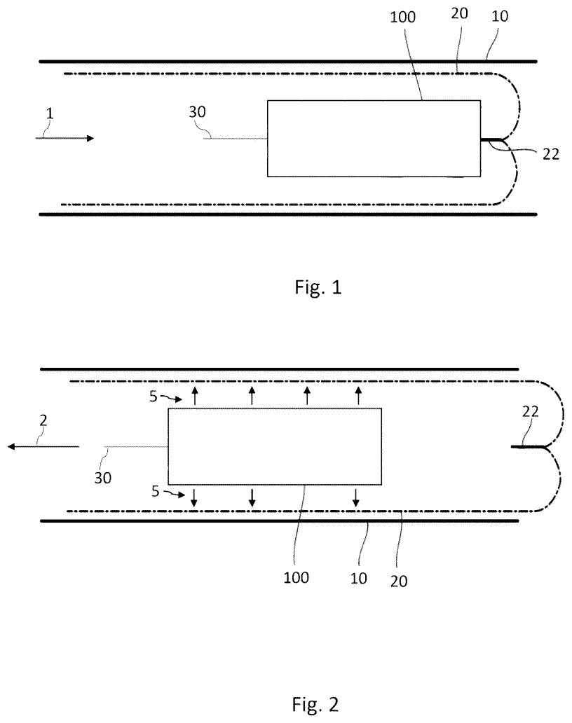

In the following, unless otherwise stated, the same reference signs are used for like and similarly acting elements. FIGS. 1 and 2 schematically show an inversion process. In particular, FIG. 1 schematically shows a drawing-in of a liner 20 and of a curing head 100 into a pipe 10, and FIG. 2 schematically shows a removal of the curing head 100 from the pipe 10 in order to cure the previously drawn-in liner 20.

Inversion processes can be used to restore and/or reinforce a pipe 10 using a liner 20. The liner 20 can be made of a flexible material, such as corrosion resistant synthetic and/or glass fibers.

Specifically, the liner 20 can have an inner side impregnated with a curable material. In some embodiments, the curable material can be a resin. The liner 20 can be drawn into the pipe 10 in a drawing-in direction 1, as shown in FIG. 1, so that the inner side impregnated with the curable material is turned outwards and lies against the inner wall of the pipe 10. For this purpose, air or water can be introduced into the inside of the liner 20, for example, whereby the liner 20 progressively adheres to the inner wall of the pipe 10. In order to pressurize the inside of the liner 20, one end of the liner 20 can be attached to an air or water supply device (not shown). The other end of the liner 20, which is drawn into the pipe 10, can be closed. The closed end moves into the pipe 10 as the liner 20 continues to be inverted.

After the liner 20 has been drawn in, the curable material can be cured with heat or UV light so that the liner 20 bonds firmly to the pipe 10. For this purpose, a curing head 100, which is connected to the closed end of the liner 20 via a short cable 22, for example, can be drawn into the pipe 10 together with the liner 20. After the liner 20 and the curing head 100 have been drawn into the pipe 10, the connection between the curing head 100 and the liner 20 or the cable 22 can be released. As shown in FIG. 2, the curing head 100 can then be pulled back to the entrance of the pipe 10 by means of a pull cable 30 and under heat or light radiation S in a pull-out direction 2, which is opposite to the drawing-in direction 1, in order to cure the curable material.

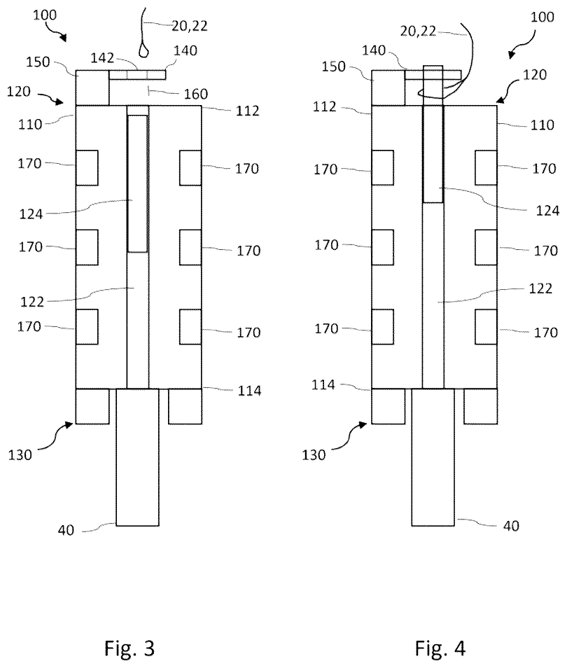

FIG. 3 schematically shows a device 100 for curing a liner drawn into a pipe in an inversion process with an open pneumatic coupling according to embodiments of the present disclosure. FIG. 4 shows the device 100 with the pneumatic coupling closed. The device 100 is also referred to as a “curing head” in the context of the present disclosure.

The device 100 comprises a body element 110 having a first end portion 112 and a second end portion 114; a pneumatic coupling 120 at the first end portion 112 of the body element 110, wherein the pneumatic coupling 120 is set up for connection to a liner 20 to be inverted; and a traction coupling 130 at the second end portion 114 of the body element 110, wherein the traction coupling 130 is set up for connection to a pull cable (not shown).

The pneumatic coupling 120 can, for example, be detachably connected or connectable to the cable 22 shown in FIG. 1 at the closed end of the liner 20 so that the device 100 can be drawn into the pipe together with the liner 20. In addition, the traction coupling 130 can be connected or connectable to the pull cable 30 shown in FIG. 1 so that the device 100 can be pulled out of the pipe after the liner 20 has been drawn in and the pneumatic coupling 120 has been released from the liner 20.

In some embodiments, the pneumatic coupling 120 can include a cylinder 122 and a piston 124 that is arranged to move linearly within the cylinder 122. By pressurizing the cylinder 122, the piston 124 can be moved linearly. For example, the cylinder 122 can be connected to a pressure generating device outside the pipe via a compressed air line 40 so that compressed air can be supplied to the cylinder 122 from the outside.

The cylinder 122 can extend partially or completely through the body element 110. In particular, the cylinder 122 can extend between the first end portion 112 and the second end portion 114 along a longitudinal axis of the body element 110. In some embodiments, the cylinder 122 and the piston 124 are arranged substantially centrally in the body element 110 or are centered in the body element 110.

The piston 124 is movable between a first position or stance (FIG. 2) and a second position or stance (FIG. 1). In particular, the piston 124 can hold the liner 20 in the first position and release the liner 20 in the second position. In other words, the first position can be a closed position (corresponding to a closed pneumatic coupling, see FIG. 2), and the second position can be an open position (corresponding to an open pneumatic coupling, see FIG. 1).

In some embodiments, the piston 124 can protrude or extend in the first position at the first end portion 112 of the body element 110 to engage with the liner 20 or a fastening element on the liner 20 to hold the liner 20 at the first end portion 112 of the body element 110, as shown in FIG. 2. Further, the piston 124 can be moved from the first position to the second position so that the piston 124 does not protrude or extend, or only slightly protrudes or extends at the first end portion 112 of the body element 110 to release the liner 20 or the fastening element on the liner 20, as shown in FIG. 1.

The pneumatic coupling 120 can be set up so that the piston 124 moves from the second position to the first position when pressure is applied via the compressed air line 40, and moves from the first position to the second position when pressure is released. The pressure can be released, for example, by opening a lever or valve that is connected to the compressed air line 40.

In some embodiments, the device 100 can further comprise at least one elastic element (not shown) arranged to exert a force on the piston 124 towards the second position. For example, the at least one elastic element can move, in particular push, the piston 124 from the first position to the second position during a pressure release to release the liner 20. The at least one elastic element can, for example, be a spring.

In some embodiments, the device 100 can include a receiving element 140 in or on the first end portion 112 of the body element 110 that is set up to receive an end portion of the piston 124 in the first position. An end of the piston 124 protruding from the cylinder 122 can thus be fixed, such that damage or deformation of the piston 124 by a pulling force exerted on the piston 124 by the liner 20 can be prevented. In addition, accidental disengagement of the liner 20 from the pneumatic coupling 120 can be avoided.

The receiving element 140 can have an opening 142 into which the piston 124 can be inserted. The opening 142 can, for example, be a recess, a hole or a through-hole in the receiving element 140.

In some embodiments, the receiving element 140 can be formed as a protrusion or web. The receiving element 140 can extend in a first extension direction over the cylinder 122 and the piston 124, so that the piston 124 meets the receiving element 140 when it is extended from the cylinder 122. For example, the opening 142 can be arranged coaxially to the longitudinal axis of the cylinder 122 and/or the longitudinal axis of the piston 124, so that the piston 124 can be inserted into the opening 142 and guided out of the opening 142. The first extension direction can be substantially perpendicular to the longitudinal axis of the body element 110 and/or to the longitudinal axis of the cylinder 122 and/or to the longitudinal axis of the piston 124.

The device 100 can further comprise a support 150 which extends at the first end portion 112 of the body element 110 in a second extension direction which is perpendicular to the first extension direction, for example upwards. The second extension direction can be substantially parallel to the longitudinal axis of the body element 110 and/or to the longitudinal axis of the cylinder 122 and/or to the longitudinal axis of the piston 124.

The support 150 can be designed as a projection. The receiving element 140 can extend from one side of the support 150, so that the receiving element 140 is arranged above the piston 124.

The device 100 can further comprise a receiving space 160 formed between one end of the cylinder 122, in particular the first end portion 112 of the body element 110, and the receiving element 140. The receiving space 160 can be open on one side and delimited on another side by the support 150, such that an eyelet of the liner 20 or an eyelet of a fastening element connected to the liner 20 is insertable into the receiving space 160 when the piston 124 is in the second position (FIG. 1). The piston 124 can extend through the eyelet and close the previously open side of the receiving space 160 when the piston 124 is in the first position to hold the liner 20 (FIG. 2).

In some embodiments, the body element 110 and/or the receiving element 140 and/or the support 150 can be formed in one piece.

The device 100 typically further comprises at least one curing device 170 arranged on the body element 110. The at least one curing device 170 is set up to emit energy for curing the liner drawn into the pipe, such as heat or light, in particular UV light. Typically, the at least one curing device 170 comprises one or more LEDs. In some embodiments, a plurality of curing devices 170, such as a plurality of LEDs, can be arranged concentrically around the longitudinal axis of the body element 110 on an outer surface of the body element 110.

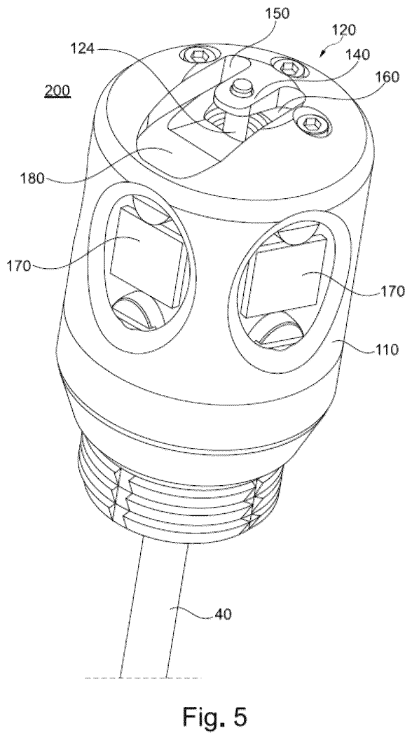

FIG. 5 schematically shows a device 200 for curing a liner drawn into a pipe in an inversion process according to further embodiments of the present disclosure.

The device 200 is similar to the device shown in FIGS. 3 and 4 and reference is made to the description of FIGS. 3 and 4 for a description of similar or identical features and properties.

In the example of FIG. 5, the receiving element 140 is a protrusion or web and extends over the piston 124 in a first extension direction so that the piston 124 meets the receiving element 140 when extending from the cylinder 122. The device 200 further comprises the support 150 which extends at the first end portion 112 of the body element 110 in a second extension direction which is perpendicular to the first extension direction, for example upwards. The receiving element 140 can extend from a side of the support 150 such that the receiving element 140 is disposed above the piston 124.

The receiving element 140 and the support 150 can be formed in one piece and define the receiving space 160.

In some embodiments, the receiving element 140 can have a wedge shape. The wedge-shaped receiving element 140 can taper from an end located, for example, at the support 150 towards an open end and thus can be wider at the end located at the support 150 than at the open end. This can prevent the liner from getting caught when the pneumatic coupling 120 is opened and from becoming detached from the pneumatic coupling 120.

In some embodiments, the body element 110 has an indentation 180 at the first end portion, in particular at an end face of the body element 110, in which indentation the outlet of the cylinder 122 and the receiving element 140 as well as the protruding part of the piston 124 are arranged. The indentation 180 can be defined, for example, by the support 150. For example, the support 150 can have a U-shaped cutout that forms or defines the indentation 180 and also the receiving space 160.

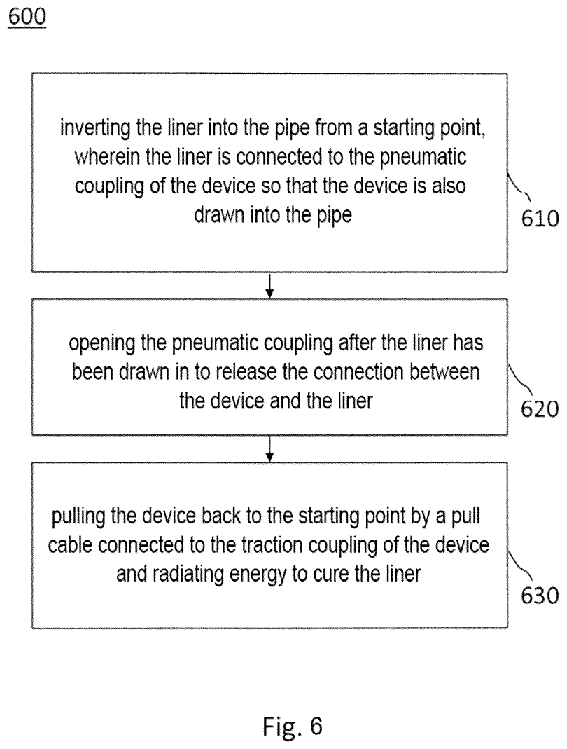

FIG. 6 shows a flow chart of a method 600 for curing a liner drawn into a pipe in an inversion process according to embodiments of the present disclosure. The method 600 utilizes the device or curing head of the present disclosure.

The method 600 comprises, in block 610, inverting the liner into the pipe from a starting point, wherein the liner is connected to the pneumatic coupling of the device so that the device is also drawn into the pipe; in block 620, opening the pneumatic coupling after the liner has been drawn in, to release the connection between the device and the liner; and in block 630, pulling the device back to the starting point by a pull cable connected to the traction coupling of the device and radiating energy to cure the liner.

According to the invention, a pneumatic coupling is provided on the curing head and enables the curing head to be pneumatically disconnected from the liner remotely after the liner has been drawn into the pipe. Once the connection to the liner has been disconnected, the curing head can be pulled out of the pipe by means of the pull cable, wherein the curing head can emit heat or light, for example, during removal in order to cure the liner that has been pulled into the pipe. This means, for example, that it is not necessary to release the pressure in the liner after the liner has been pulled in and before the curing head is pulled out. As a result, the quality of the pipe restoration can be improved. In addition, the pneumatic coupling can be small so that little installation space is required for the pneumatic coupling and can also be used for pipes with a small internal diameter and/or small curing heads.

Although the invention has been illustrated and explained in detail by preferred embodiments, the invention is not limited by the disclosed examples and other variations can be derived by the person skilled in the art without departing from the scope of protection of the invention. It is therefore clear that a large number of possible variations exist. It is also clear that embodiments mentioned by way of example really only represent examples, which are not to be understood in any way as limiting, for example, the scope of protection, the possible applications or the configuration of the invention. Rather, the above description and the description of the figures enable the person skilled in the art to carry out the exemplary embodiments in a specific manner, wherein the person skilled in the art, knowing the disclosed concept of the invention, can make a variety of changes, for example with regard to the function or the arrangement of individual elements mentioned in an exemplary embodiment, without departing from the scope of protection defined by the claims and their legal equivalents, such as further explanations in the description.

1. A device for curing a liner drawn into a pipe in an inversion process, comprising:
a body element having a first end portion and a second end portion;
a pneumatic coupling at the first end portion of the body element, wherein the pneumatic coupling is set up for connection to a liner to be inverted; and
a traction coupling at the second end portion of the body element, wherein the traction coupling is set up for a connection to a pull cable.

2. The device of claim 1, wherein the pneumatic coupling comprises a cylinder and a piston, wherein the piston is movably arranged in the cylinder, in particular wherein the cylinder extends through the body element.

3. The device of claim 2, wherein the piston is movable along a longitudinal axis of the body element between a first position and a second position, and/or wherein the piston is set up to hold the liner in the first position and to release the liner in the second position.

4. The device of claim 3, wherein the piston is set up to move from the second position to the first position when pressurized, and to move from the first position to the second position when depressurized.

5. The device of claim 3, further comprising at least one elastic element arranged to exert a force on the piston towards the second position, in particular wherein the at least one elastic element is a spring.

6. The device of claim 3, further comprising a receiving element set up to receive an end portion of the piston in the first position.

7. The device of claim 6, wherein:
the receiving element is a projection; and/or
the receiving element is a web, and/or
the receiving element is formed in one piece with the body element.

8. The device of claim 6, wherein:
the receiving element has a wedge shape; and/or
the receiving element has an opening into which the piston can be inserted.

9. The device of claim 6, further comprising a receiving space formed between one end of the cylinder and the receiving element.

10. The device of claim 9, wherein an eyelet of the liner or a fastening element connected to the liner is insertable into the receiving space when the piston is in the second position, and wherein the piston extends through the eyelet when the piston is in the first position, to hold the liner.

11. The device of claim 1, further comprising at least one curing device arranged on the body element, in particular wherein the at least one curing device is set up to emit energy for curing the liner.

12. The device of claim 11, wherein a plurality of curing devices are arranged concentrically around a longitudinal axis of the body element.

13. A method for curing a liner drawn into a pipe in an inversion process with the device of claim 1, comprising:
inverting the liner into the pipe from a starting point, wherein the liner is connected to the pneumatic coupling of the device so that the device is also drawn into the pipe;
opening the pneumatic coupling after the liner has been drawn in to release the connection between the device and the liner; and
pulling the device back to the starting point by a pull cable connected to the traction coupling of the device and radiating energy to cure the liner.
